(19) United States
(12) Patent Application Publication
(10) Pub. No.: US 2012/0214485 A1
(43) Pub. Date: Aug. 23, 2012

(54) Systems and Methods for Emergency Arming of a Network Access Device

(75) Inventors: Gerhard Wessels, Ebersberg (DE); Ulrich Schaefer, Brunnthal (DE); Christoph Schmickler, Steinhoring (DE)

(73) Assignee: CONTINENTAL AUTOMOTIVE GMBH, Hannover (DE)

(21) Appl. No.: 13/392,484

(22) PCT Filed: Aug. 26, 2009
(86) PCT No.: PCT/EP09/06192

§ 371 Date: May 8, 2012

(51) Int. Cl. H04W 60/00

(52) U.S. Cl. 455/435.1

(57) ABSTRACT

Methods and systems for emergency registration of a vehicle network access device are disclosed, including monitoring one or more vehicle risk indicators; analyzing the one or more vehicle risk indicators for the likelihood of an emergency; and initiating registration of the vehicle network access device in response to analyzing the one or more vehicle risk indicators.

### CROSS REFERENCE TO RELATED APPLICATION

This is a U.S. national stage of application No. PCT/EP2009/006192, filed on 26 Aug. 2009.

### BACKGROUND OF THE INVENTION

### Field of the Invention

The invention relates generally to emergency registration of a vehicle network access device for at least one of an emergency call or a service call.

### SUMMARY OF THE INVENTION

Disclosed is a method for emergency registration of a vehicle network access device, the method comprising: monitoring one or more vehicle risk indicators; analyzing the one or more vehicle risk indicators for the likelihood of an emergency; and initiating registration of the vehicle network access device in response to analyzing the one or more vehicle risk indicators.

An apparatus for emergency network access registration comprises one or more processors; one or more memory units coupled to the one or more processors; a vehicle network access device coupled to the one or more processors. The apparatus is configured to: monitor one or more vehicle risk indicators; analyze the one or more vehicle risk indicators for the likelihood of an emergency; and cause a registration of the vehicle network access device.

In one embodiment, disclosed is a computer program product stored on a computer operable medium, the computer program product comprising software code being effective to register a vehicle network access device prior to an emergency by being effective to: monitor one or more vehicle risk indictors; analyze the one or more vehicle risk indicators for the likelihood of the emergency; and cause a registration of the vehicle network access device in response to the analysis of the one or more vehicle risk indicators.

Numerous additional embodiments are also possible.

### BRIEF DESCRIPTION OF THE DRAWINGS

Other objects and advantages of the invention may become apparent upon reading the detailed description and upon reference to the accompanying drawings.

FIG. 1 is a block diagram of a system for emergency registration of a vehicle network access device based on one or more risk indicators;

FIG. 2 is a block diagram of an apparatus for emergency network access registration based on one or more risk indicators;

FIG. 3 is a flow chart of a method for emergency registration of a network access device;

FIG. 4 is a flow chart a method for emergency registration of a vehicle network access device based on one or more risk indicators;

FIG. 5 is a flow chart of an alternative embodiment of a method for emergency registration of a vehicle network access device based on one or more risk indicators.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

In at least one embodiment vehicle risk indicators are monitored for the probability for the occurrence of an accident. The vehicle risk indicators comprise brake force indication, vehicle stability, radar sensors, speed, tire pressure sensors, cameras, lane departure warning system, driver drowsiness detection, warning lights, voice recognition, car to car communication, and steering angle. If the probability exceeds a threshold, then the registration of the vehicle network access device is initiated. The probability threshold may be exceeded if for example the tire pressure sensor suddenly registers a drastic change in tire pressure. The sudden change in tire pressure could be a result of a tire puncture or blowout. After such an event, registration of the vehicle network access device would be initiated. The vehicle risk indicators are monitored to determine whether or not to stream the accident or emergency information. Another example of a vehicle risk indicator that could possibly initiate the vehicle network access registration is brake force indication. If the brakes are applied with maximum force, the probability threshold for an emergency may be exceeded and therefore vehicle network access initiated. These are only a few of examples in which the vehicle risk indicators could exceed the probability threshold for an emergency.

In one embodiments, the emergency arming of a network access device relieves the network carriers from having to register a device that a majority of the time will not be communicating on the network. Network carriers do not want, especially if the network access devices are not communicating and generating revenue for the network carriers, and in some cases cannot handle the registration of all the network access devices for all the vehicles on the road.

In one embodiment, the emergency arming of a network access device may reduce the time it takes to start streaming the accident information after an accident has occurred. By starting to register the network access device based on the risk indicators of the vehicle, if an accident does indeed occur, then the disabled vehicle may be able to start streaming the accident information sooner after the accident, instead of having to first wait for the network access registration. Typically, it takes at least one minute to register the vehicle network access device to the network and place a call. The time saved by the emergency arming of a network access device may be very valuable in being able to respond to the accident.

In one embodiment, the emergency arming of a network access device may be able to alert emergency responders to a potentially catastrophic accident. If the network access is abruptly terminated as a result of the destruction of the vehicle's network access device during the crash, then the network carrier may be able to alert emergency responders on the basis that the vehicle's network access was registered due to the high probability of a crash based on one or more risk indicators.

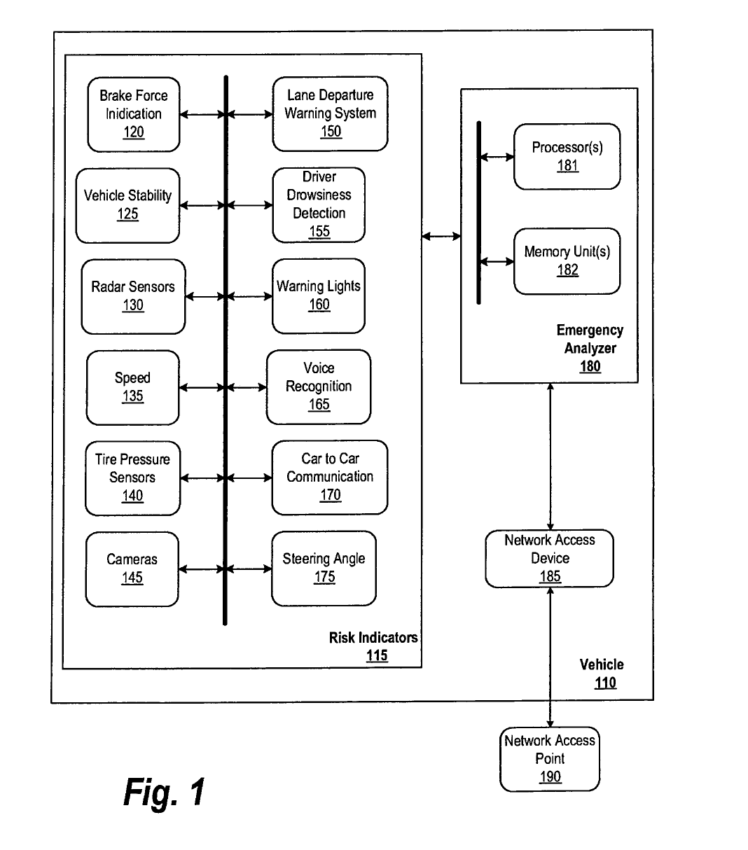

FIG. 1 is a block diagram of a system for emergency registration of a vehicle network access device based on one or more risk indicators.

In one embodiment, vehicle 110 comprises risk indicators 115. The risk indicators comprise brake force indication 120, vehicle stability 125, radar sensors 130, speed 135, tire pressure sensors 140, cameras 145, lane departure warning system 150, driver drowsiness detection 155, warning lights 160, voice recognition 165, car to car communication 170, and steering angle 175. The risk indicators 115 are analyzed with an emergency analyzer 180 to determine when there is a high likelihood of a crash. The emergency analyzer includes of one or more processors 181 and one or more memory units 182. If it is determined that a high likelihood of a crash exists, then registration of a vehicle network access device 185 to a network access point 190 is initiated.

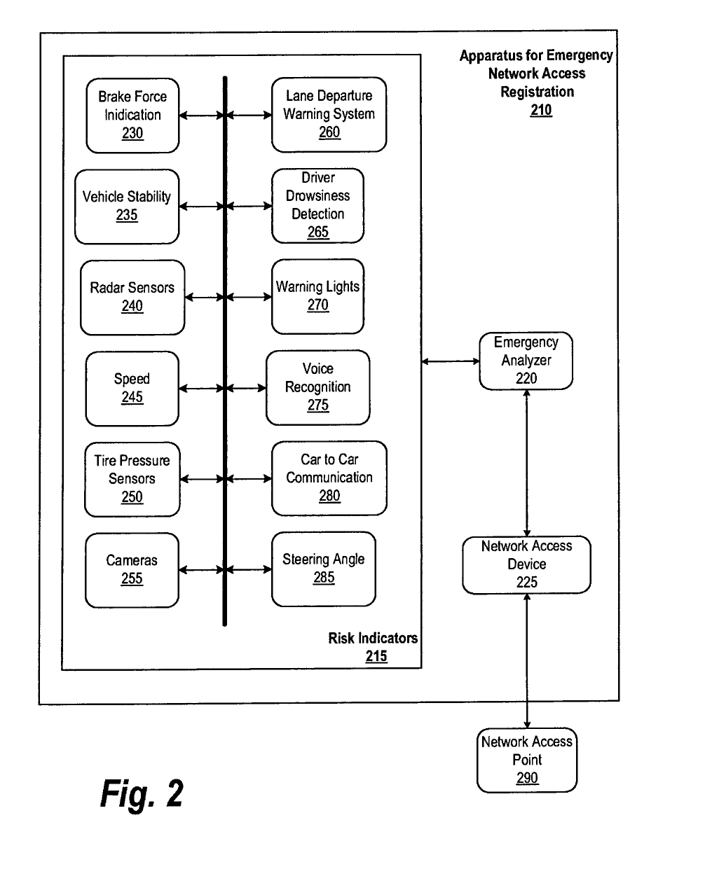

FIG. 2 is a block diagram of an apparatus for emergency network access registration based on one or more risk indicators.

In one embodiment, an apparatus for emergency network access registration 210 comprises risk indicators 215, an emergency analyzer 220 and a network access device 225. The risk indicators comprise brake force indication 230, vehicle stability 235, radar sensors 240, speed 245, tire pressure sensors 250, cameras 255, lane departure warning system 260, driver drowsiness detection 265, warning lights 270, voice recognition 275, car to car communication 280, and steering angle 285. The risk indicators 215 are analyzed with the emergency analyzer 220 to determine when there is a high likelihood of a crash. If it is determined that a high likelihood of a crash exists, then registration of the network access device 225 to a network access point 290 is initiated.

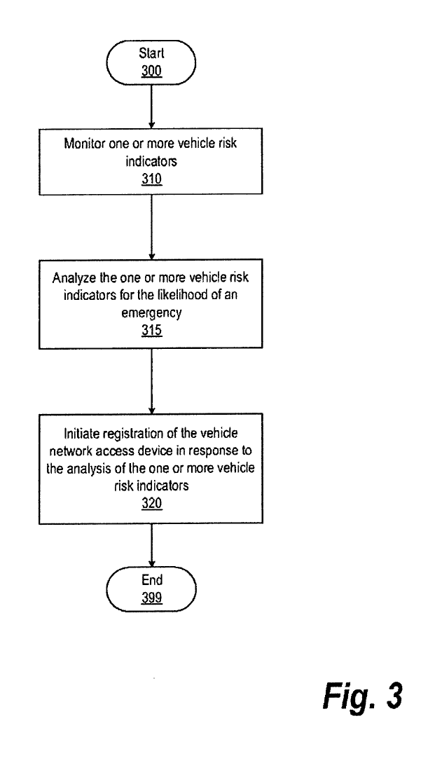

FIG. 3 is a flow chart of a method for emergency registration of a network access device. In one embodiment, the method illustrated in FIG. 3 may be performed by one or more of the devices illustrated in FIG. 1 and FIG. 2. Processing begins at 300 whereupon, at block 310 one or more vehicle risk indicators are monitored. At block 315, the one or more vehicle risk indicators are analyzed for the likelihood of an emergency. At block 320, registration of the vehicle network access is initiated in response to the analysis of the one or more vehicle risk indicators. Processing subsequently ends at 399.

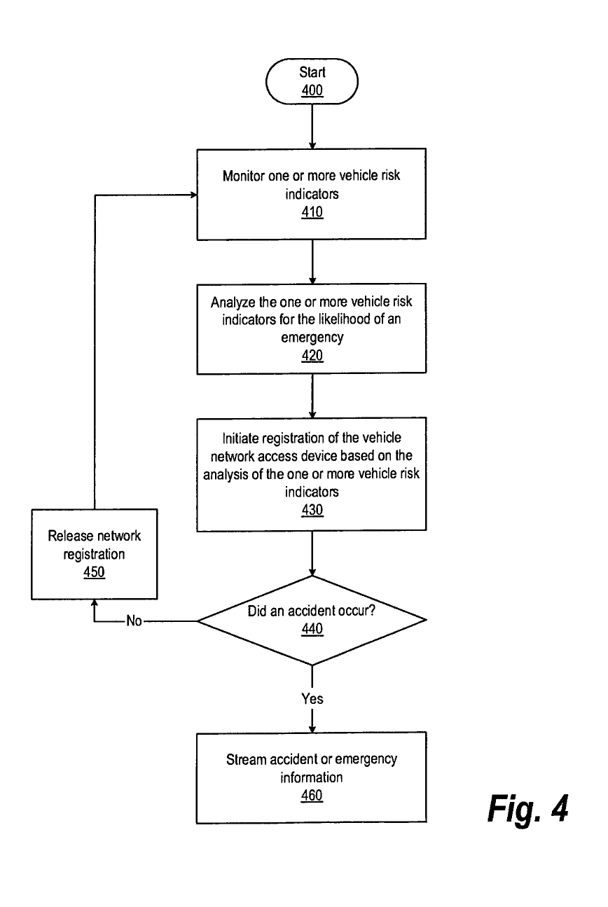

FIG. 4 is a flow chart of a method for emergency registration of a vehicle network access device based on one or more risk indicators.

Processing begins at 400 whereupon, at block 410, one or more vehicle risk indicators are monitored. In block 420, one or more vehicle risk indicators are analyzed for the likelihood of an emergency. In block 430 the registration of the vehicle network access device is initiated based on the analysis of the one or more vehicle risk indicators. Next it is determined whether an accident occurred 440. If an accident did not occur, the network registration is released 450. If an accident did occur, then the accident or emergency information may be streamed 460 to the service center.

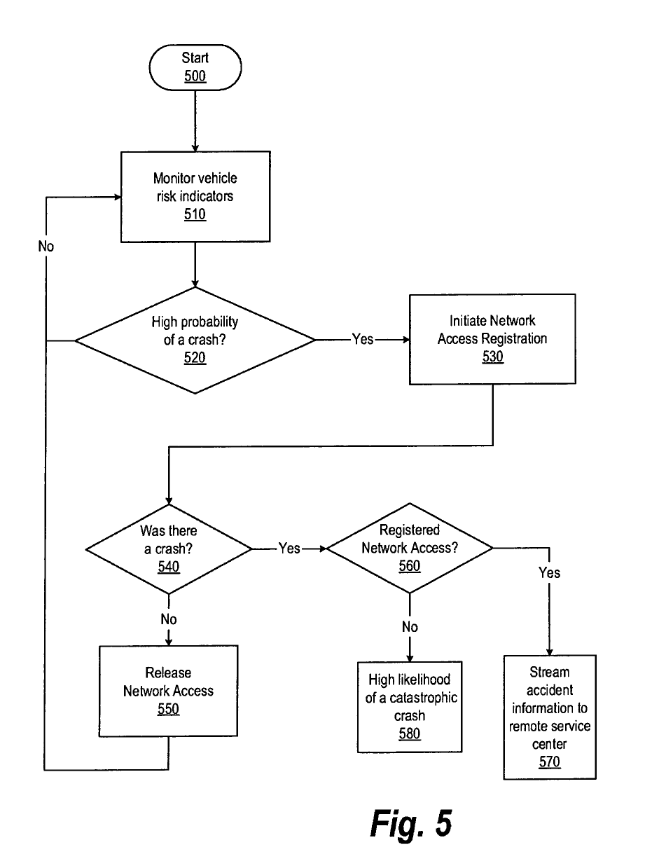

FIG. 5 is a flowchart of an alternative embodiment of a method for emergency registration of a vehicle network access device based on one or more risk indicators.

Processing begins at 500 whereupon, at block 510, the vehicle risk indicators are monitored. The risk indicators are used in determining the likelihood of a crash in block 520. If there is not a high likelihood of a crash, then the risk indicators are continued to be monitored by returning to block 510. If there is a high likelihood of a crash, then network access registration is initiated in block 530. In block 540, the risk indicators are analyzed to determine whether a crash occurred. If the analysis of the risk indicators do not show a crash has occurred, then the network access is released in block 550 and the risk indicators are continued to be monitored in block 510. If a crash did occur, network access is checked in block 560. If there is network access, then the accident information is streamed to a remote service center in block 570. In block 580, if there is no network access, then there is a high likelihood that a catastrophic crash had occurred that may have abruptly terminated the network access. The service center that initially received the network access registration in block 530 will then at least know that there was at least a high probability of a crash based on the risk indicators prior to the abrupt termination of the network access and based on this information, the service center may be able to alert emergency responders.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-13. (canceled)

14. A method for emergency registration of a vehicle network access device, comprising:
monitoring at least one vehicle risk indicator;
analysing the at least one vehicle risk indicators to determine a likelihood of an emergency; and
initiating network registration of a vehicle network access device in response to the analysis of the at least one vehicle risk indicator.

15. The method of claim 14, wherein the at least one vehicle risk indicator comprise at least one of brake force indication, vehicle stability, radar sensors, speed, tire pressure sensors, cameras, lane departure warning system, driver drowsiness detection, warning lights, voice recognition, car to car communication, and steering angle.

16. The method of claim 14, further comprising releasing the network registration if the emergency did not occur.

17. The method of claim 14, further comprising streaming accident information if the emergency did occur.

18. An apparatus for emergency network access registration, comprising:
one or more processors;
one or more memory units coupled to the one or more processors;
a vehicle network access device coupled to the one or more processors;
the apparatus being configured to:
monitor at least one vehicle risk indicator;
analyze the at least one vehicle risk indicator for a likelihood of an emergency; and
cause a registration of the vehicle network access device.

19. The apparatus of claim 18, wherein the apparatus is configured to monitor the at least one vehicle risk indicator which are at least one of: brake force indication, vehicle stability, radar sensors, speed, tire pressure sensors, cameras, lane departure warning system, driver drowsiness detection, warning lights, voice recognition, car to car communication, and steering angle.

20. The apparatus of claim 18, wherein the apparatus is further configured to release the network registration if the emergency did not occur.

21. The apparatus of claim 18, wherein the apparatus is further configured to stream accident information if the emergency did occur.

22. The apparatus of claim 18, further comprising a vehicle, wherein the apparatus is mounted to the vehicle.

23. A computer program product stored on a non-transitory computer operable medium, the computer program product comprising software code being effective to register a vehicle network access device prior to an emergency by being effective to:
monitor one or more vehicle risk indictors;
analyse the one or more vehicle risk indicators for the likelihood of an emergency; and
cause a registration of the vehicle network access device in response to the analysis of the one or more vehicle risk indicators.

24. The computer program product of claim 23, wherein the software code is further effective to monitor the one or more vehicle risk indicators which comprises monitoring at least one of: brake force indication, vehicle stability, radar sensors, speed, tire pressure sensors, cameras, lane departure warning system, driver drowsiness detection, warning lights, voice recognition, car to car communication, and steering angle.

25. The computer program product of claim 23, wherein the software code is further effective to release network registration if the emergency did not occur.

26. The computer program product of claim 23, wherein the software code is further effective to stream accident information if the emergency did occur.
